(19) United States
(12) Patent Application Publication
(10) Pub. No.: US 2025/0200560 A1
(43) Pub. Date: Jun. 19, 2025

(54) SINGLE CASH BALANCE

(71) Applicant: Coinbase, Inc., Oakland, CA (US)

(72) Inventors: Muneeb Imtiaz, New York, NY (US); Naveen Reddy Dendi, Dublin, CA (US)

(21) Appl. No.: 18/389,760

(22) Filed: Dec. 19, 2023

(51) Int. Cl. G06Q 20/38; G06Q 20/36

(52) U.S. Cl. CPC G06Q 20/381; G06Q 20/3672; G06Q 20/389

(57) ABSTRACT

Methods, systems, and devices for data management are described. A custodial token platform may receive a first amount of fiat to be associated with a user profile at the custodial token platform. The custodial token platform may display, at a user interface, a fiat amount corresponding to the first amount and a stablecoin amount corresponding to a second amount of stablecoin associated with the user profile. The custodial token platform may receive an input to enable a single amount setting and convert, after receiving the input, the fiat amount to stablecoin. The custodial token platform may convert the fiat amount to stablecoin via a minting contract. The custodial token platform may display, via the user interface, the stablecoin amount without displaying the fiat amount, where the stablecoin amount is updated to include the converted fiat amount.

### FIELD OF TECHNOLOGY

The present disclosure relates generally to data management, including techniques for enabling a single cash balance on a custodial token platform.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 shows examples of computing environments that support enabling a single cash balance on a custodial token platform in accordance with aspects of the present disclosure.

FIG. 3 shows an example of a user interface flow that supports enabling a single cash balance on a custodial token platform in accordance with aspects of the present disclosure.

FIG. 4 shows an example of a process flow that supports enabling a single cash balance on a custodial token platform in accordance with aspects of the present disclosure.

FIG. 5 shows a block diagram of an apparatus that supports enabling a single cash balance on a custodial token platform in accordance with aspects of the present disclosure.

FIG. 6 shows a block diagram of a crypto token manager that supports enabling a single cash balance on a custodial token platform in accordance with aspects of the present disclosure.

FIG. 7 shows a diagram of a system including a device that supports enabling a single cash balance on a custodial token platform in accordance with aspects of the present disclosure.

FIGS. 8 and 9 show flowcharts illustrating methods that support enabling a single cash balance on a custodial token platform in accordance with aspects of the present disclosure.

### DETAILED DESCRIPTION

A user profile on a custodial token platform may be associated with one or more currency balances. For example, the user profile may be associated with a fiat wallet having an amount of fiat currency (e.g., United States Dollar (USD)), a stablecoin wallet having an amount of stablecoin (e.g., USDC), one or more crypto token wallets having respective amounts of crypto tokens (e.g., Ether (ETH)), or any combination thereof.

A user may leverage amounts from the fiat wallet and the stablecoin wallet for similar transactions or use-cases on the custodial token platform. For example, the user may leverage an amount of the fiat currency or the stablecoin currency to purchase an amount of a crypto token. However, the stablecoin wallet may be associated with greater capabilities than the fiat wallet outside of the custodial token platform. For example, the user may leverage the stablecoin wallet in a blockchain environment as the stablecoin wallet may be associated with a public key and/or a private key enabling the user to perform cryptographic operations, such as signatures, transactions, transfers, or the like via the corresponding blockchain network. As the fiat wallet and the stablecoin wallet are associated with overlapping use-cases on the custodial token platform and the stablecoin wallet may be associated with more use-cases outside of the custodial token platform, the user profile and/or the user experience may be simplified by implementing a single stablecoin balance instead of both a fiat balance and a stablecoin balance. That is, the user experience may be enhanced both on the custodial token platform and outside the custodial token platform (e.g., in the blockchain environment) when, for example, purchasing the amount of the crypto token by using the single stablecoin balance.

As described herein, the custodial token platform may receive requests for and enable a single cash balance for a user profile. For example, the custodial token platform may display, via a user interface, an option to enable the single cash balance based on a user profile being associated with the fiat wallet. That is, the custodial token platform may have received, prior to displaying the option to enable the single cash balance, an amount of a fiat currency to be associated with the user profile. If the user selects the option to enable the single cash balance, the custodial token platform may convert (e.g., automatically) a fiat balance associated with the user profile to a stablecoin balance. For example, the custodial token platform may broadcast a message configured to call a minting contract, where the minting contract may mint an amount of stablecoin equal to the fiat balance. The custodial token platform may display, via the user interface, the stablecoin balance in the stablecoin wallet without the fiat balance and/or fiat wallet after the conversion. When the custodial token platform receives additional deposits of fiat amounts for the user profile, it may automatically convert the fiat amounts to stablecoin (e.g., via calling the minting contract). In some examples, the custodial token platform may also display an option to disable the single cash balance.

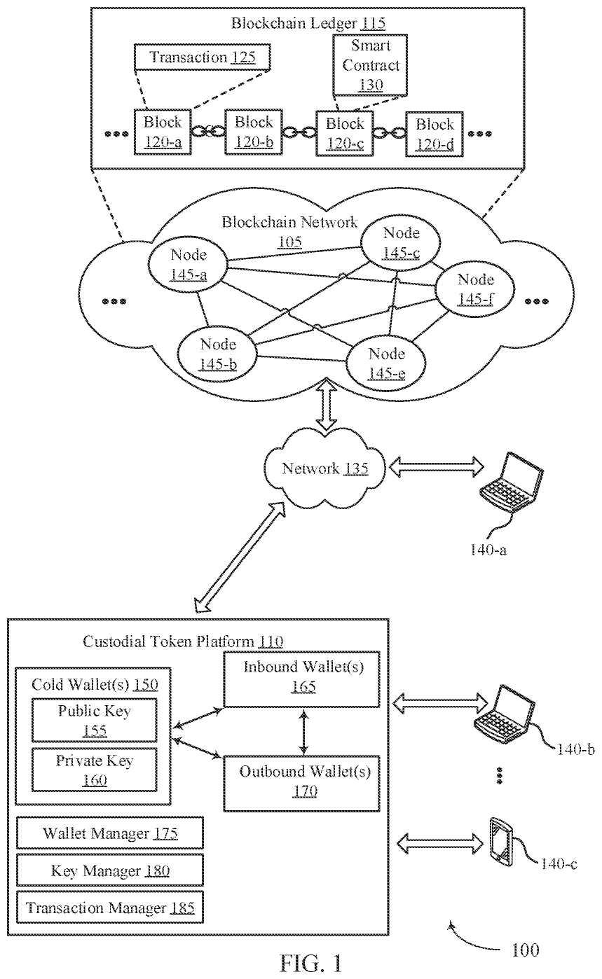

FIG. 1 illustrates an example of a computing environment 100 that supports enabling a single cash balance on a custodial token platform in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

As described herein, the custodial token platform 110 may enable a single cash balance for a user profile based on receiving one or more inputs. For example, the custodial token platform 110 may display an option to enable the single cash balance via, for example, a user interface of the computing device 140-b or the computing device 140-c. The computing device 140-b or the computing device 140-c may include a client application associated with the custodial token platform 110 by which a user may provide the one or more inputs. The custodial token platform 110 may display the option to enable the single cash balance based on the user profile being associated with a fiat balance. That is, the custodial token platform 110 may have received some amount of fiat currency for the user profile prior to displaying the option to enable the single cash balance. The custodial token platform 110 may call a minting contract by broadcasting a message via the blockchain network 105. In other words, the custodial token platform 110 may broadcast a message configured to call the minting contract and mint an amount of stablecoin equal to the fiat balance of the user profile. The custodial token platform 110 may display the stablecoin amount based on converting the fiat balance to stablecoin via the minting contract, and the custodial token platform 110 may not display a fiat balance after receiving the input to enable the single cash balance and/or performing the conversion.

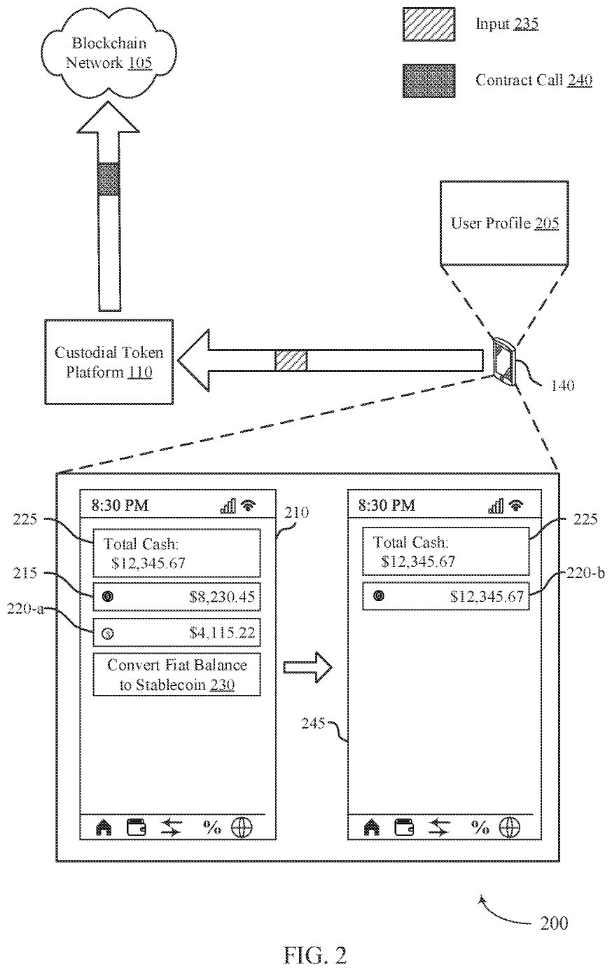

FIG. 2 shows an example of a computing environment 200 that supports enabling a single cash balance on a custodial token platform in accordance with aspects of the present disclosure. The computing environment may include a blockchain network 105, a custodial token platform 110, and a computing device 140 which may be examples of corresponding devices as described with reference to FIG. 1. The computing environment 200 may also include a user profile 205, which may be associated with the custodial token platform 110 as described with reference to FIG. 1.

The custodial token platform 110 may display, via a user interface of the computing device 140, multiple balances associated with a user profile 205 of the custodial token platform 110. For example, a user interface 210 of the computing device 140 may display the multiple balances associated with the user profile 205. That is, the user interface 210 may display a fiat balance 215 (e.g., $8,230.45), a stablecoin balance 225-a (e.g., $4,115.22), a crypto token balance, and a total balance (e.g., a total cash balance of $12,345.67).

A fiat balance 215 may be associated with a fiat currency. In some examples, the fiat balance 215 may be stored as and/or referred to as a “wallet” associated with the user profile 205. However, the fiat balance 215 may not have a capability to perform cryptographic operations, such as operations requiring a public and/or private key. In other words, the fiat balance 215 may be different than the wallets described with reference to FIG. 1. Thus, the fiat balance 215 may have reduced functionality (e.g., use-cases) when compared to, for example, the stablecoin balance 225-a in a blockchain environment.

As such, the user interface 210 may include an option to convert a fiat balance to stablecoin 230. In some examples, the custodial token platform 110 may display the option to convert the fiat balance to stablecoin 230 based on the user profile 205 having the fiat balance 215. For example, the custodial token platform 110 may receive an amount of fiat currency for the user profile 205. In other words, a user may deposit (e.g., transfer an amount of fiat currency from an external account, perform a bank transfer, etc.) the amount of fiat currency at the custodial token platform 110. The amount of fiat currency, in some examples, may be stored outside of the custodial token platform 110, but be accessible (e.g., usable) for one or more transactions on the custodial token platform 110. For example, the user may purchase an amount of stablecoin, an amount of a crypto token, or the like with the fiat balance 215.

The custodial token platform 110 may receive an input 235 via the user interface 210 of the computing device 140 indicating that the user has selected to convert the fiat balance to stablecoin 230. In some aspects, the option to convert the fiat balance to stablecoin 230 may be referred to as enabling a single cash balance. For example, a single cash balance may refer to the user profile 205 being associated with a stablecoin balance (e.g., and one or more crypto token balances), rather than the fiat balance 215 and the stablecoin balance 220-a. That is, the custodial token platform 110, if the single cash balance is enabled, may automatically convert current and future fiat balances to stablecoin and default to the stablecoin (e.g., not present the fiat currency) for transactions on the custodial token platform 110.

Based on receiving the input 235 enabling the single cash balance, the custodial token platform 110 may broadcast a contract call 240. The contract call 240 may call a minting contract, which may be a blockchain supported (e.g., Ethereum network supported) contract, to mint an amount of stablecoin equal to the fiat balance 215. For example, the minting contract may mint the amount of the stablecoin based on a conversion rate between the fiat currency and the stablecoin currency. In the example of a conversion from USD to USDC, the conversion rate may be 1:1. The custodial token platform 110 may broadcast the contract call 240 to call the minting contract and mint the stablecoin as opposed to, for example, purchasing the amount of stablecoin on the market (e.g., a market buy). In other words, the custodial token platform 110 may convert the fiat balance to an amount of stablecoin by minting stablecoin and locking (e.g., burning) the fiat balance, for example, at a reserve associated with the fiat balance (e.g., USD reserves).

In some aspects, the custodial token platform 110 may also convert limit orders (e.g., existing on the custodial token platform exchange or market) associated with the fiat currency for the user profile to be associated with stablecoin. In other words, a denomination of the limit order may be converted according to whether the user profile is opted-in to the single cash balance. Further, any subsequent access to an exchange or market may display exchange rates (e.g., conversion ratios) using the stablecoin rather than fiat.

The custodial token platform 110 may display, at a user interface 245 of the computing device 140, a stablecoin balance 235-b (e.g., $12,345.67) and the total balance 225 (e.g., $12,345.67). That is, the user interface 245 may not include the fiat balance 215 and/or the option to convert the fiat balance to stablecoin 230 after the conversion. The stablecoin balance 235-b may be updated to include the amount of stablecoin minted via the contract call 240, and the total balance 225 may be the same as the stablecoin balance 235-b (e.g., as the stablecoin is the only cash balance associated with the user profile 205). In other words, the stablecoin balance 235-b may include an additional amount of stablecoin (e.g., as opposed to the stablecoin balance 235-a before the conversion) equal to the fiat balance 215.

The custodial token platform 110 may automatically convert amounts of fiat currency deposited by and/or received by the user profile 205 to stablecoin. For example, the custodial token platform 110 may receive the amounts of fiat currency via a deposit (e.g., a bank transfer), via a trade involving the fiat currency, or the like. The custodial token platform 110, based on receiving the amounts of fiat currency, may broadcast the contract call 240 to mint the incoming amounts of fiat currency to stablecoin. The user interface 245 may be updated to include a new stablecoin balance according to the amount of fiat currency deposited and subsequently converted via minting to stablecoin.

In some examples, the user interface 245 may display an option to opt out of the single cash balance. For example, the custodial token platform 110 may receive an input to enable a fiat wallet for the user profile 205. The custodial token platform 110 may display, via a user interface of the computing device 140, a fiat balance based on receiving the input. The fiat balance may be zero upon the fiat wallet being re-enabled. That is, the custodial token platform 110 may not convert amounts of stablecoin and/or crypto tokens to the fiat currency after receiving the input.

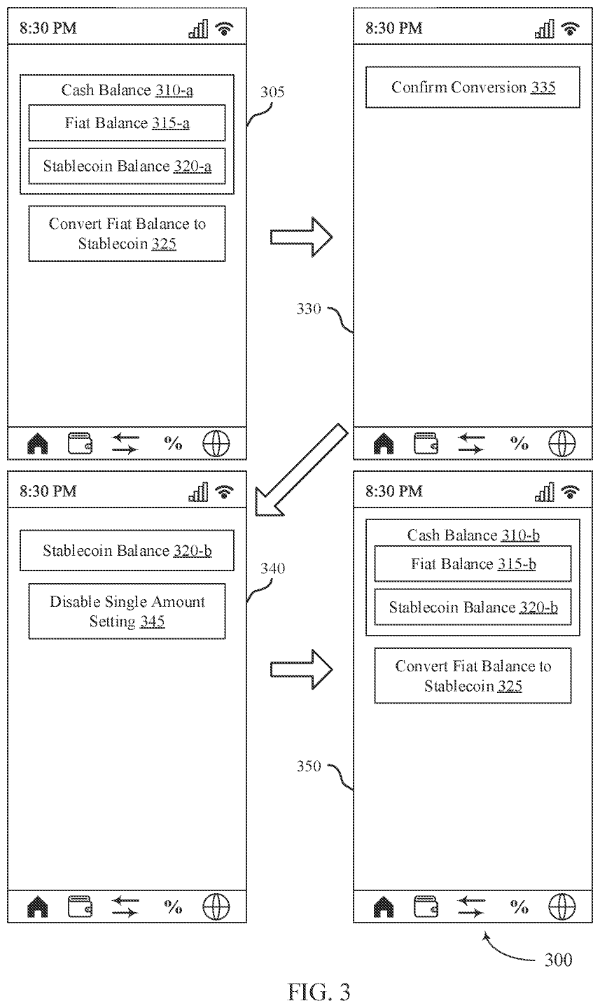

FIG. 3 shows an example of a user interface flow 300 that supports single cash balance in accordance with aspects of the present disclosure. The user interface flow 300 may be implemented by a client application of a custodial token platform on a user device. For example, the user interface flow 300 may be implemented by the custodial token platform 110 via the computing device 140 as described with reference to FIG. 2.

A user interface may display multiple content items to support on-chain attestations as described herein. The user interface flow 300 includes an example of the user interface where the multiple content items may be displayed to enable a user to select a single cash balance a custodial token platform, such as the custodial token platform 110 as described with reference to FIG. 1 and FIG. 2.

At a user interface 305, the custodial token platform may display, according to a user profile of the custodial token platform, a cash balance 310-a including a fiat balance 315-a and a stablecoin balance 320-a as well as an option to convert the fiat balance to stablecoin 325. In other words, the user interface 305 may include the fiat balance 315-a and the stablecoin balance 320-a associated with the user profile.

The custodial token platform may display the option to convert the fiat balance to stablecoin 325 based on the user profile having the fiat balance 315-a. Additionally, or alternatively, the custodial token platform may display the option to convert the fiat balance to stablecoin 325 to a user profile not having a fiat balance. For example, the custodial token platform may display the option to convert the fiat balance to stablecoin 325 for user profiles having fiat balances, or for user profiles not having fiat balances. That is, the user profile having the fiat balance 315-a may select the option to convert the fiat balance to stablecoin 325 for the current fiat balance (e.g., the fiat balance 315-a, a legacy fiat balance, etc.) as well as future amounts of fiat received by the custodial token platform for the user profile, while a user profile not having a fiat balance may select the option to convert a fiat balance to stablecoin 325 for future deposits of fiat received by the custodial token platform for the user profile. In other words, the option to convert the fiat balance to stablecoin 325 may enable automatic conversion of future deposits, which may be applicable to user profiles having fiat balances and not having fiat balances.

In some examples, the user interface 305 may display information associated with the option to convert the fiat balance to stablecoin 325. For example, the information may include one or more benefits associated with using the stablecoin balance 320-a versus the fiat balance 315-a, a rate of return (e.g., a reward percentage) associated with using the stablecoin balance 320-a, or the like. In some aspects, an amount of the information may be based on whether the user profile is associated with a fiat balance, an amount of fiat associated with the user profile, or both. For example, the custodial token platform may display more information to users having a fiat balance, or, in some examples, users having fiat balances exceeding a threshold.

The custodial token platform may display a user interface 330 including an option to confirm a conversion 335 of the fiat balance 315-a to stablecoin, as well as enable automatic conversions of amounts of fiat received in the future for the user profile to stablecoin, based on receiving an input selecting the option to convert the fiat balance to stablecoin 325. The user interface 330 may include information associated with a user agreement for the option to convert the fiat balance to stablecoin 325, which may be referred to as enabling a single cash wallet.

In some aspects, the custodial token platform may display additional information associated with enabling a single cash wallet with the option to convert the fiat balance to stablecoin 325, after receiving an input selecting the option to convert the fiat balance to stablecoin 325, or after receiving an input requesting more information. For example, throughout the user interface flow 300, the custodial token platform may display one or more options to view more information associated with the single cash wallet.

After receiving an input to confirm the conversion 335, the custodial token platform may display a user interface 340. For example, the custodial token platform may, as described with greater detail elsewhere herein, including with reference to FIG. 2, call a minting contract to mint an amount of stablecoin equal to the fiat balance 315-a. That is, the conversion of the fiat balance 315-a to stablecoin may include minting the amount of stablecoin equal to the fiat balance 315-a.

The user interface 340 may include, after the conversion, a stablecoin balance 320-b and an option to disable the single amount setting 345. For example, the custodial token platform may not display a fiat balance when the single cash balance option is enabled. Additionally, or alternatively, the user interface 340 may include an option to deposit an amount. For example, the user interface 340 may include the option to deposit an amount of fiat to be automatically converted to stablecoin based on the single cash balance setting being enabled. In some aspects, the option to disable the single amount setting 345 may be available via a settings tab (e.g., rather than an assets tab where the stablecoin balance 320-b may be presented).

The custodial token platform may receive an input selecting the option to disable the single amount setting 345. After receiving the input, the custodial token platform may display a user interface 350 including a cash balance 310-b with a fiat balance 315-b and the stablecoin balance 320-b, as well as the option to convert the fiat balance to stablecoin 325. The fiat balance 315-b, after the user profile has disabled the single cash balance setting, may include a zero balance. For example, the custodial token platform may not convert an amount of stablecoin and/or an amount of a crypto token to fiat after receiving the input disabling the single amount setting. The stablecoin balance 320-b may remain the same before and after receiving the input disabling the single amount setting.

Additionally, or alternatively, the custodial token platform may, again, display the option to convert the fiat balance to stablecoin 325. That is, the custodial token platform may display the option to enable the single cash balance to user profiles not having the setting enabled.

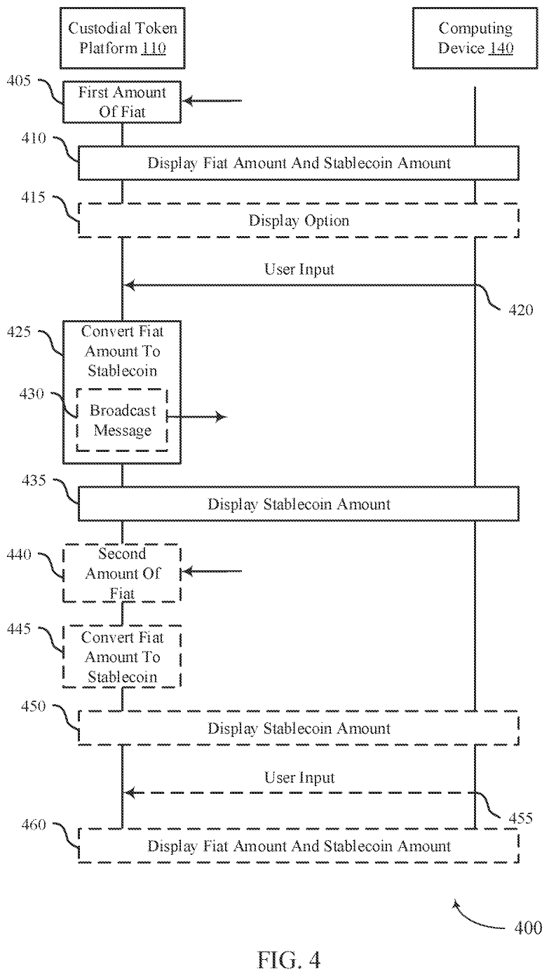

FIG. 4 shows an example of a process flow 400 that supports enabling a single cash balance on a custodial token platform in accordance with aspects of the present disclosure. In some examples, the process flow 400 may implement or be implemented by aspects of the computing environment 100, the computing environment 200, or the user interface flow 300 as described with reference to FIGS. 1-3. For example, the process flow 400 may include a custodial token platform 110 and a computing device 140 which may be examples of corresponding devices as described with reference to FIGS. 1 and 2.

Alternative examples of the following may be implemented, where some steps are performed in a different order than described or are not performed at all. In some cases, steps may include additional features not mentioned below, or further steps may be added. Although the custodial token platform 110 and the computing device 140 are shown performing the operations of the process flow 400, some aspects of some operations may also be performed by one or more other devices or systems.

The custodial token platform 110 may support a single cash balance. For example, a user profile may opt to enable the single cash balance, where a current amount of fiat currency and/or future amounts of fiat currency associated with the user profile may be automatically converted to stablecoin. The single cash balance may simplify a user experience on the custodial token platform 110 and/or in a blockchain environment where the stablecoin may be associated with more capabilities than the fiat, such as capabilities to perform cryptographic and/or blockchain operations.

At 405, the custodial token platform 110 may receive a first amount of fiat. For example, the custodial token platform 110 may receive the first amount of fiat associated with the user profile. In some aspects, the custodial token platform 110 may receive the first amount of fiat via a deposit (e.g., a bank transfer), via a transaction, or the like.

At 410, the custodial token platform 110, via a user interface of the computing device 140, may display a fiat amount and a stablecoin amount. For example, the fiat amount may include the first amount of fiat received at 405 and an amount of fiat associated with the user profile before the first amount of fiat was received at 405. The fiat amount, in some aspects, may be referred to as a fiat balance and/or a fiat wallet. However, the fiat wallet may not be blockchain enabled (e.g., associated with keys, able to perform cryptographic operations, etc.). The stablecoin amount may be referred to as a stablecoin balance and/or a stablecoin wallet. The stablecoin wallet may be blockchain enabled (e.g., associated with one or more keys). The fiat wallet and the stablecoin wallet may each be referred to as “cash” wallets and/or “cash” balances.

At 415, the custodial token platform 110, via the user interface of the computing device 140, may display an option to enable a single cash balance. For example, the option to enable the single cash balance may include converting the fiat amount to stablecoin (e.g., the fiat amount associated with the user profile at 415) and converting (e.g., automatically) amounts of fiat received after the single cash balance is enabled.

At 420, the custodial token platform 110 may receive a user input via the user interface of the computing device 140. For example, the custodial token platform 110 may receive the user input to enable the single cash balance.

At 425, the custodial token platform 110 may convert the fiat amount to stablecoin. For example, the custodial token platform 110 may, at 430, broadcast a message configured to call a minting contract. The minting contract may mint an amount of stablecoin equal to the fiat amount associated with the user profile. Additionally, or alternatively, the minting contract may mint the amount of stablecoin to be associated with a blockchain address associated with the user profile.

At 435, the custodial token platform 110 may display the stablecoin amount via the user interface of the computing device 140. That is, after converting the fiat amount to stablecoin at 425, the custodial token platform 110 may display a single cash balance (e.g., the stablecoin amount). In other words, the custodial token platform 110 may display the stablecoin amount without the fiat amount. The stablecoin amount at 435 may be updated to include the amount of fiat converted to stablecoin at 425. That is, the stablecoin amount at 435 may include an additional amount of stablecoin compared to the fiat amount at 410 equal to the amount of fiat converted to stablecoin at 425. The additional amount of stablecoin may vary according to a conversion rate between a fiat currency and a stablecoin currency.

After enabling (e.g., opting in to) the single cash balance, a user may, via the user interface of the computing device 140, deposit an amount of fiat and/or stablecoin, transfer an amount of stablecoin (e.g., to an external account, exchange to a fiat amount, etc.), exchange the stablecoin for crypto tokens, send and/or receive stablecoin (e.g., gift stablecoin), or the like.

At 440, the custodial token platform 110 may receive a second amount of fiat. For example, the custodial token platform 110 may receive the second amount of fiat associated with the user profile. The custodial token platform 110 may receive the second amount of fiat via a deposit, a transaction, or the like.

At 445, the custodial token platform 110 may convert the second amount of fiat to stablecoin. For example, the custodial token platform 110 may automatically convert the second amount of fiat to stablecoin based on receiving the user input at 420 enabling the single cash balance.

At 450, the custodial token platform 110 may display the stablecoin amount. For example, the custodial token platform 110 may update the stablecoin amount displayed at 435 to include an additional amount of stablecoin after the conversion of the second fiat amount to stablecoin at 445.

At 455, the custodial token platform 110 may receive a user input via the user interface of the computing device 140. For example, the custodial token platform 110 may receive an input disabling or opting out of the single cash balance. The custodial token platform 110, after receiving the input enabling the single cash balance at 420, may display an option to opt out. That is, the custodial token platform 110 may receive the user input opting out of the single cash balance based on displaying the option to opt out via the user interface of the computing device 140.

At 460, the custodial token platform 110 may display a fiat amount and the stablecoin amount. For example, after receiving the input opting out of the single cash balance at 455, the custodial token platform 110 may (e.g., again) display the fiat amount. The fiat amount may be zero after the custodial token platform 110 receives the input to opt out of the single cash balance. For example, the custodial token platform 110 may not convert any amount of stablecoin and/or crypto token to fiat after receiving the input opting out of the single cash balance. As such, the user profile may be associated with a zero balance of fiat until making a deposit or transaction using fiat.

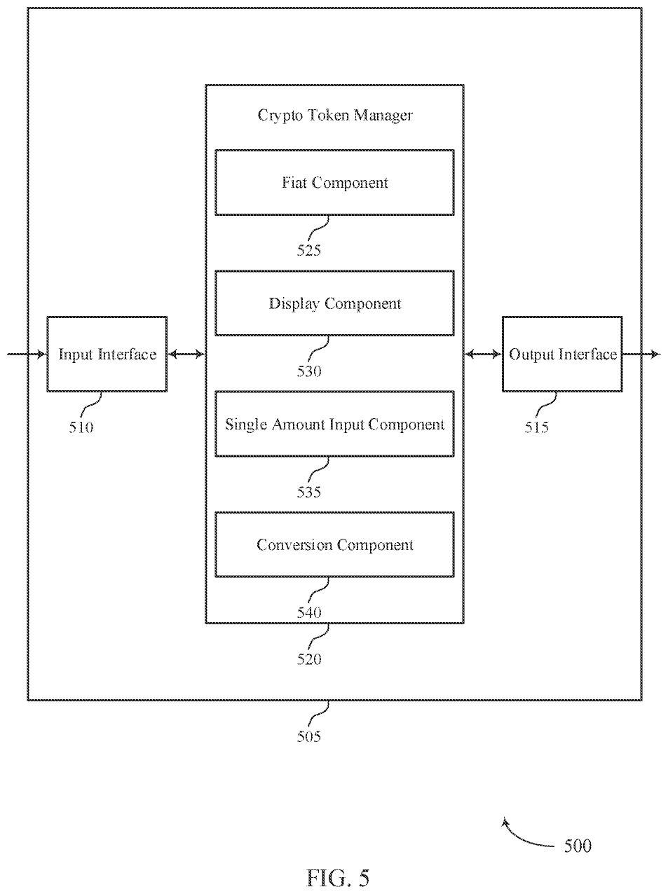

FIG. 5 shows a block diagram 500 of a system 505 that supports enabling a single cash balance on a custodial token platform in accordance with aspects of the present disclosure. The system 505 may include an input interface 510, an output interface 515, and a crypto token manager 520. The system 505, or one or more components of the system 505 (e.g., the input interface 510, the output interface 515, and the crypto token manager 520), may include at least one processor, which may be coupled with at least one memory, to support the described techniques Each of these components may communicate, directly or indirectly, with one another (e.g., via one or more buses, communications links, communications interfaces, or any combination thereof).

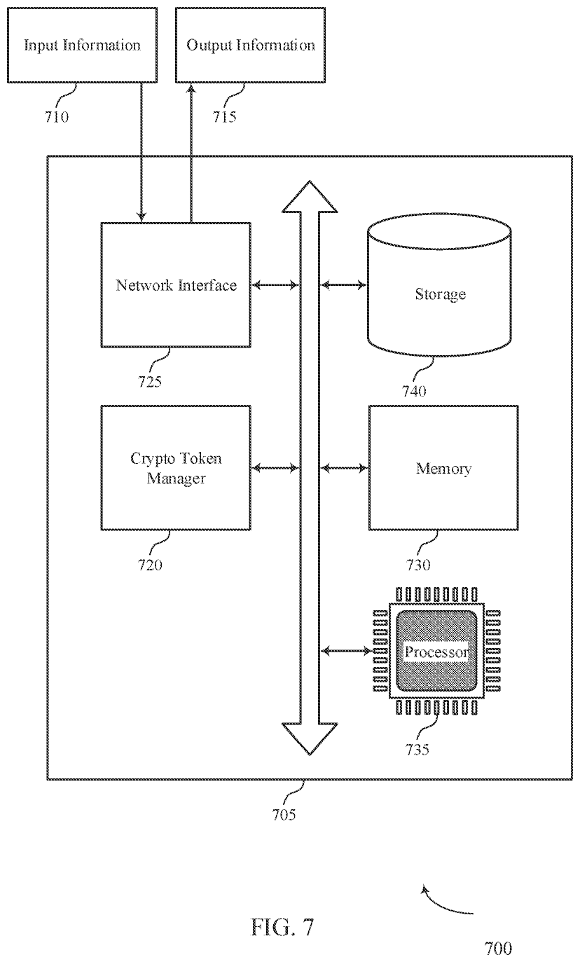

The input interface 510 may manage input signaling for the system 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the crypto token manager 520 to support enabling a single cash balance on a custodial token platform. In some cases, the input interface 510 may be a component of a network interface 725 as described with reference to FIG. 7.

The output interface 515 may manage output signaling for the system 505. For example, the output interface 515 may receive signaling from other components of the system 505, such as the crypto token manager 520, and may transmit such output signaling corresponding to (e.g., representative of or otherwise based on) such signaling to other systems or devices. In some cases, the output interface 515 may be a component of a network interface 725 as described with reference to FIG. 7.

For example, the crypto token manager 520 may include a fiat component 525, a display component 530, a single amount input component 535, a conversion component 540, or any combination thereof. In some examples, the crypto token manager 520, or various components thereof, may be configured to perform various operations (e.g., receiving, monitoring, transmitting) using or otherwise in cooperation with the input interface 510, the output interface 515, or both. For example, the crypto token manager 520 may receive information from the input interface 510, send information to the output interface 515, or be integrated in combination with the input interface 510, the output interface 515, or both to receive information, transmit information, or perform various other operations as described herein.

The crypto token manager 520 may support crypto token management in accordance with examples as disclosed herein. The fiat component 525 may be configured as or otherwise support a means for receiving a first amount of fiat to be associated with a user profile at a custodial token platform. The display component 530 may be configured as or otherwise support a means for displaying, at a user interface of the custodial token platform, a fiat amount corresponding to the first amount and a stablecoin amount corresponding to a second amount of stablecoin associated with the user profile. The single amount input component 535 may be configured as or otherwise support a means for receiving, at the custodial token platform, an input to enable a single amount setting. The conversion component 540 may be configured as or otherwise support a means for converting, after receiving the input, the fiat amount to the stablecoin. The display component 530 may be configured as or otherwise support a means for displaying, at the user interface, the stablecoin amount without displaying the fiat amount, wherein the stablecoin amount is updated to include the converted fiat amount.

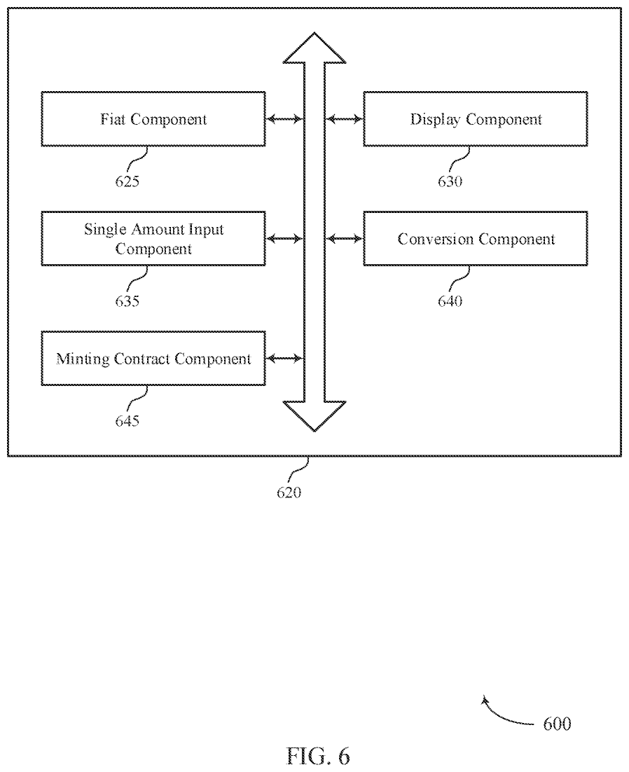

FIG. 6 shows a block diagram 600 of a crypto token manager 620 that supports enabling a single cash balance on a custodial token platform in accordance with aspects of the present disclosure. The crypto token manager 620 may be an example of aspects of a crypto token manager 520, a custodial token platform 110, or both, as described herein. The crypto token manager 620, or various components thereof, may be an example of means for performing various aspects of enabling a single cash balance on a custodial token platform as described herein. For example, the crypto token manager 620 may include a fiat component 625, a display component 630, a single amount input component 635, a conversion component 640, a minting contract component 645, or any combination thereof. Each of these components may communicate, directly or indirectly, with one another (e.g., via one or more buses, communications links, communications interfaces, or any combination thereof).

The crypto token manager 620 may support crypto token management in accordance with examples as disclosed herein. The fiat component 625 may be configured as or otherwise support a means for receiving a first amount of fiat to be associated with a user profile at a custodial token platform. The display component 630 may be configured as or otherwise support a means for displaying, at a user interface of the custodial token platform, a fiat amount corresponding to the first amount and a stablecoin amount corresponding to a second amount of stablecoin associated with the user profile. The single amount input component 635 may be configured as or otherwise support a means for receiving, at the custodial token platform, an input to enable a single amount setting. The conversion component 640 may be configured as or otherwise support a means for converting, after receiving the input, the fiat amount to the stablecoin. In some examples, the display component 630 may be configured as or otherwise support a means for displaying, at the user interface, the stablecoin amount without displaying the fiat amount, wherein the stablecoin amount is updated to include the converted fiat amount.

In some examples, the fiat component 625 may be configured as or otherwise support a means for receiving a third amount of fiat to be associated with the user profile at the custodial token platform. In some examples, the conversion component 640 may be configured as or otherwise support a means for converting, based at least in part on having received the input, the third amount of fiat to the stablecoin. In some examples, the display component 630 may be configured as or otherwise support a means for displaying, at the user interface, the stablecoin amount that is updated to include the third amount of fiat.

In some examples, to support converting the fiat amount to the stablecoin, the minting contract component 645 may be configured as or otherwise support a means for broadcasting a message that is configured to call a minting contract for the stablecoin, the minting contract configured to mint an amount of the stablecoin equal to the fiat amount associated with the user profile, wherein displaying the stablecoin amount that is updated to include the converted fiat amount is based at least in part on broadcasting the message.

In some examples, the message is configured to cause the converted fiat amount to be associated with a blockchain address associated with the user profile.

In some examples, the single amount input component 635 may be configured as or otherwise support a means for receiving at the custodial token platform, a second input to disable the single amount setting.

In some examples, the display component 630 may be configured as or otherwise support a means for displaying, based at least in part on receiving the second input and at a user interface of the custodial token platform, a fiat amount and a stablecoin amount associated with the user profile.

In some examples, the fiat amount is zero.

In some examples, to support receiving the input to enable the single amount setting, the display component 630 may be configured as or otherwise support a means for displaying, at the user interface, an option to enable the single amount setting based at least in part on receiving the first amount of fiat. In some examples, to support receiving the input to enable the single amount setting, the single amount input component 635 may be configured as or otherwise support a means for receiving, based at least in part on displaying the option to enable the single amount setting, the input.

FIG. 7 shows a diagram 700 of a system 705 that supports enabling a single cash balance on a custodial token platform in accordance with aspects of the present disclosure. The system 705 may be an example of or include the components of a system 505 as described herein. The system 705 may include components to support a enabling a single cash balance on a custodial token platform, such as a crypto token manager 720, an input information 710, an output information 715, a network interface 725, at least one memory 730, at least one processor 735, and a storage 740. Each of these components may communicate, directly or indirectly, with one another (e.g., via one or more buses, communications links, communications interfaces, or any combination thereof).

The network interface 725 may enable the system 705 to exchange information (e.g., input information 710, output information 715, or both) with other systems or devices (not shown). For example, the network interface 725 may enable the system 705 to connect to a network (e.g., a network 135 as described herein). The network interface 725 may include one or more wireless network interfaces, one or more wired network interfaces, or any combination thereof.

Memory 730 may include RAM, ROM, or both. The memory 730 may store computer-readable, computer-executable software including instructions that, when executed, cause at least one processor 735 to perform various functions described herein, such as functions supporting enabling a single cash balance on a custodial token platform. In some cases, the memory 730 may contain, among other things, a basic input/output system (BIOS), which may control basic hardware or software operation such as the interaction with peripheral components or devices. In some cases, the memory 730 may be an example of aspects of one or more components of a custodial token platform 110 as described with reference to FIG. 1. The memory 730 may be an example of a single memory or multiple memories. For example, the system 705 may include one or more memories 730.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in at least one memory 730 to perform various functions (e.g., functions or tasks supporting enabling a single cash balance on a custodial token platform). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. The processor 735 may be an example of a single processor or multiple processors. For example, the system 705 may include one or more processors 735.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1.

The crypto token manager 720 may support crypto token management in accordance with examples as disclosed herein. For example, the crypto token manager 720 may be configured as or otherwise support a means for receiving a first amount of fiat to be associated with a user profile at a custodial token platform. The crypto token manager 720 may be configured as or otherwise support a means for displaying, at a user interface of the custodial token platform, a fiat amount corresponding to the first amount and a stablecoin amount corresponding to a second amount of stablecoin associated with the user profile. The crypto token manager 720 may be configured as or otherwise support a means for receiving, at the custodial token platform, an input to enable a single amount setting. The crypto token manager 720 may be configured as or otherwise support a means for converting, after receiving the input, the fiat amount to the stablecoin. The crypto token manager 720 may be configured as or otherwise support a means for displaying, at the user interface, the stablecoin amount without displaying the fiat amount, wherein the stablecoin amount is updated to include the converted fiat amount.

By including or configuring the crypto token manager 720 in accordance with examples as described herein, the system 705 may support techniques for improved user experience related to automatic conversion of fiat deposits in a custodial token platform to stablecoin amounts.

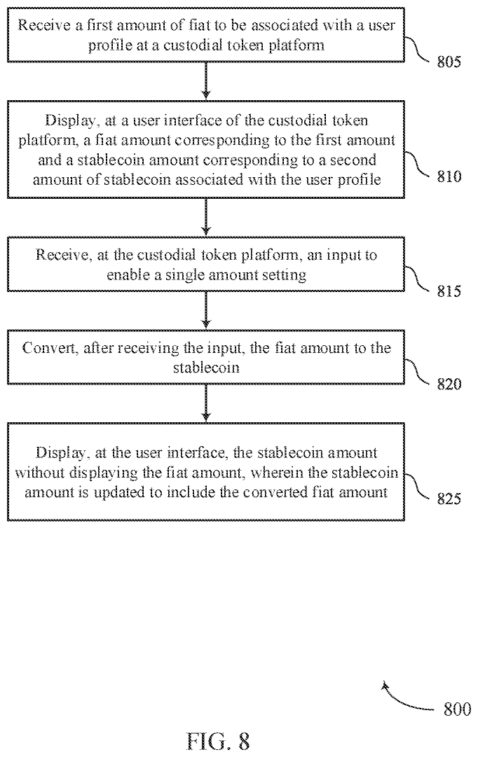

FIG. 8 shows a flowchart illustrating a method 800 that supports enabling a single cash balance on a custodial token platform in accordance with aspects of the present disclosure. The operations of the method 800 may be implemented by a custodial token platform or its components as described herein. For example, the operations of the method 800 may be performed by a custodial token platform as described with reference to FIGS. 1 through 7. In some examples, a custodial token platform may execute a set of instructions to control the functional elements of the custodial token platform to perform the described functions. Additionally, or alternatively, the custodial token platform may perform aspects of the described functions using special-purpose hardware.

At 805, the method may include receiving a first amount of fiat to be associated with a user profile at a custodial token platform. The operations of block 805 may be performed in accordance with examples as disclosed herein. In some examples, aspects of the operations of 805 may be performed by a fiat component 625 as described with reference to FIG. 6.

At 810, the method may include displaying, at a user interface of the custodial token platform, a fiat amount corresponding to the first amount and a stablecoin amount corresponding to a second amount of stablecoin associated with the user profile. The operations of block 810 may be performed in accordance with examples as disclosed herein. In some examples, aspects of the operations of 810 may be performed by a display component 630 as described with reference to FIG. 6.

At 815, the method may include receiving, at the custodial token platform, an input to enable a single amount setting. The operations of block 815 may be performed in accordance with examples as disclosed herein. In some examples, aspects of the operations of 815 may be performed by a single amount input component 635 as described with reference to FIG. 6.

At 820, the method may include converting, after receiving the input, the fiat amount to the stablecoin. The operations of block 820 may be performed in accordance with examples as disclosed herein. In some examples, aspects of the operations of 820 may be performed by a conversion component 640 as described with reference to FIG. 6.

At 825, the method may include displaying, at the user interface, the stablecoin amount without displaying the fiat amount, wherein the stablecoin amount is updated to include the converted fiat amount. The operations of block 825 may be performed in accordance with examples as disclosed herein. In some examples, aspects of the operations of 825 may be performed by a display component 630 as described with reference to FIG. 6.

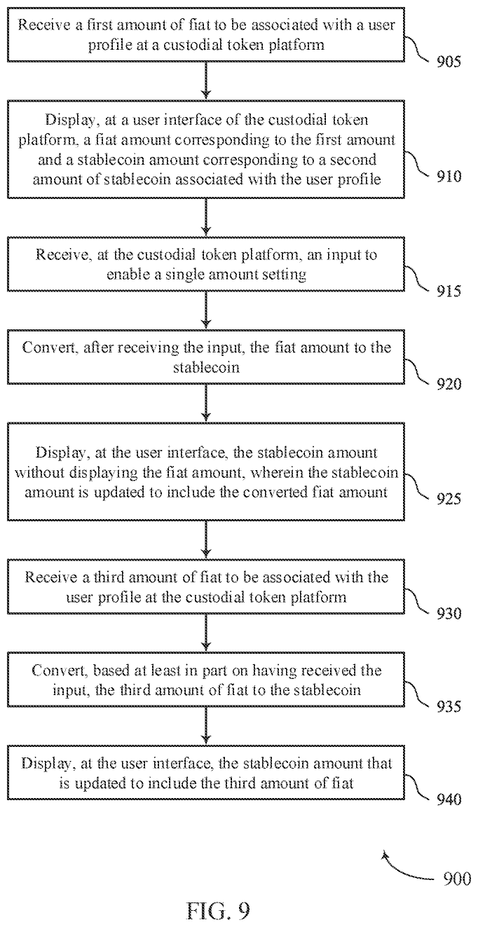

FIG. 9 shows a flowchart illustrating a method 900 that supports enabling a single cash balance on a custodial token platform in accordance with aspects of the present disclosure. The operations of the method 900 may be implemented by a custodial token platform or its components as described herein. For example, the operations of the method 900 may be performed by a custodial token platform as described with reference to FIGS. 1 through 7. In some examples, a custodial token platform may execute a set of instructions to control the functional elements of the custodial token platform to perform the described functions. Additionally, or alternatively, the custodial token platform may perform aspects of the described functions using special-purpose hardware.

At 905, the method may include receiving a first amount of fiat to be associated with a user profile at a custodial token platform. The operations of block 905 may be performed in accordance with examples as disclosed herein. In some examples, aspects of the operations of 905 may be performed by a fiat component 625 as described with reference to FIG. 6.

At 910, the method may include displaying, at a user interface of the custodial token platform, a fiat amount corresponding to the first amount and a stablecoin amount corresponding to a second amount of stablecoin associated with the user profile. The operations of block 910 may be performed in accordance with examples as disclosed herein. In some examples, aspects of the operations of 910 may be performed by a display component 630 as described with reference to FIG. 6.

At 915, the method may include receiving, at the custodial token platform, an input to enable a single amount setting. The operations of block 915 may be performed in accordance with examples as disclosed herein. In some examples, aspects of the operations of 915 may be performed by a single amount input component 635 as described with reference to FIG. 6.

At 920, the method may include converting, after receiving the input, the fiat amount to the stablecoin. The operations of block 920 may be performed in accordance with examples as disclosed herein. In some examples, aspects of the operations of 920 may be performed by a conversion component 640 as described with reference to FIG. 6.

At 925, the method may include displaying, at the user interface, the stablecoin amount without displaying the fiat amount, wherein the stablecoin amount is updated to include the converted fiat amount. The operations of block 925 may be performed in accordance with examples as disclosed herein. In some examples, aspects of the operations of 925 may be performed by a display component 630 as described with reference to FIG. 6.

At 930, the method may include receiving a third amount of fiat to be associated with the user profile at the custodial token platform. The operations of block 930 may be performed in accordance with examples as disclosed herein. In some examples, aspects of the operations of 930 may be performed by a fiat component 625 as described with reference to FIG. 6.

At 935, the method may include converting, based at least in part on having received the input, the third amount of fiat to the stablecoin. The operations of block 935 may be performed in accordance with examples as disclosed herein. In some examples, aspects of the operations of 935 may be performed by a conversion component 640 as described with reference to FIG. 6.

At 940, the method may include displaying, at the user interface, the stablecoin amount that is updated to include the third amount of fiat. The operations of block 940 may be performed in accordance with examples as disclosed herein. In some examples, aspects of the operations of 940 may be performed by a display component 630 as described with reference to FIG. 6.

A method for crypto token management by an apparatus is described. The method may include receiving a first amount of fiat to be associated with a user profile at a custodial token platform, displaying, at a user interface of the custodial token platform, a fiat amount corresponding to the first amount and a stablecoin amount corresponding to a second amount of stablecoin associated with the user profile, receiving, at the custodial token platform, an input to enable a single amount setting, converting, after receiving the input, the fiat amount to the stablecoin, and displaying, at the user interface, the stablecoin amount without displaying the fiat amount, wherein the stablecoin amount is updated to include the converted fiat amount.

An apparatus for crypto token management is described. The apparatus may include one or more memories storing processor executable code, and one or more processors coupled with the one or more memories. The one or more processors may individually or collectively operable to execute the code to cause the apparatus to receive a first amount of fiat to be associated with a user profile at a custodial token platform, display, at a user interface of the custodial token platform, a fiat amount corresponding to the first amount and a stablecoin amount corresponding to a second amount of stablecoin associated with the user profile, receive, at the custodial token platform, an input to enable a single amount setting, convert, after receiving the input, the fiat amount to the stablecoin, and display, at the user interface, the stablecoin amount without displaying the fiat amount, wherein the stablecoin amount is updated to include the converted fiat amount.

Another apparatus for crypto token management is described. The apparatus may include means for receiving a first amount of fiat to be associated with a user profile at a custodial token platform, means for displaying, at a user interface of the custodial token platform, a fiat amount corresponding to the first amount and a stablecoin amount corresponding to a second amount of stablecoin associated with the user profile, means for receiving, at the custodial token platform, an input to enable a single amount setting, means for converting, after receiving the input, the fiat amount to the stablecoin, and means for displaying, at the user interface, the stablecoin amount without displaying the fiat amount, wherein the stablecoin amount is updated to include the converted fiat amount.

A non-transitory computer-readable medium storing code for crypto token management is described. The code may include instructions executable by a processor to receive a first amount of fiat to be associated with a user profile at a custodial token platform, display, at a user interface of the custodial token platform, a fiat amount corresponding to the first amount and a stablecoin amount corresponding to a second amount of stablecoin associated with the user profile, receive, at the custodial token platform, an input to enable a single amount setting, convert, after receiving the input, the fiat amount to the stablecoin, and display, at the user interface, the stablecoin amount without displaying the fiat amount, wherein the stablecoin amount is updated to include the converted fiat amount.

Some examples of the method, apparatus, and non-transitory computer-readable medium described herein may further include operations, features, means, or instructions for receiving a third amount of fiat to be associated with the user profile at the custodial token platform, converting, based at least in part on having received the input, the third amount of fiat to the stablecoin, and displaying, at the user interface, the stablecoin amount that may be updated to include the third amount of fiat.

In some examples of the method, apparatus, and non-transitory computer-readable medium described herein, converting the fiat amount to the stablecoin may include operations, features, means, or instructions for broadcasting a message that may be configured to call a minting contract for the stablecoin, the minting contract configured to mint an amount of the stablecoin equal to the fiat amount associated with the user profile, wherein displaying the stablecoin amount that may be updated to include the converted fiat amount may be based at least in part on broadcasting the message.

In some examples of the method, apparatus, and non-transitory computer-readable medium described herein, the message may be configured to cause the converted fiat amount to be associated with a blockchain address associated with the user profile.

Some examples of the method, apparatus, and non-transitory computer-readable medium described herein may further include operations, features, means, or instructions for receiving at the custodial token platform, a second input to disable the single amount setting.

Some examples of the method, apparatus, and non-transitory computer-readable medium described herein may further include operations, features, means, or instructions for displaying, based at least in part on receiving the second input and at a user interface of the custodial token platform, a fiat amount and a stablecoin amount associated with the user profile.

In some examples of the method, apparatus, and non-transitory computer-readable medium described herein, the fiat amount may be zero.

In some examples of the method, apparatus, and non-transitory computer-readable medium described herein, receiving the input to enable the single amount setting may include operations, features, means, or instructions for displaying, at the user interface, an option to enable the single amount setting based at least in part on receiving the first amount of fiat and receiving, based at least in part on displaying the option to enable the single amount setting, the input.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for crypto token management, comprising:
receiving a first amount of fiat to be associated with a user profile at a custodial token platform;
displaying, at a user interface of the custodial token platform, a fiat amount corresponding to the first amount and a stablecoin amount corresponding to a second amount of stablecoin associated with the user profile;
receiving, at the custodial token platform, an input to enable a single amount setting;
converting, after receiving the input, the fiat amount to the stablecoin; and
displaying, at the user interface, the stablecoin amount without displaying the fiat amount, wherein the stablecoin amount is updated to include the converted fiat amount.

2. The method of claim 1, further comprising:
receiving a third amount of fiat to be associated with the user profile at the custodial token platform;
converting, based at least in part on having received the input, the third amount of fiat to the stablecoin; and
displaying, at the user interface, the stablecoin amount that is updated to include the third amount of fiat.

3. The method of claim 1, wherein converting the fiat amount to the stablecoin comprises:
broadcasting a message that is configured to call a minting contract for the stablecoin, the minting contract configured to mint an amount of the stablecoin equal to the fiat amount associated with the user profile, wherein displaying the stablecoin amount that is updated to include the converted fiat amount is based at least in part on broadcasting the message.

4. The method of claim 3, wherein the message is configured to cause the converted fiat amount to be associated with a blockchain address associated with the user profile.

5. The method of claim 1, further comprising:
receiving at the custodial token platform, a second input to disable the single amount setting.

6. The method of claim 5, further comprising:
displaying, based at least in part on receiving the second input and at a user interface of the custodial token platform, a fiat amount and a stablecoin amount associated with the user profile.

7. The method of claim 6, wherein the fiat amount is zero.

8. The method of claim 1, wherein receiving the input to enable the single amount setting comprises:
displaying, at the user interface, an option to enable the single amount setting based at least in part on receiving the first amount of fiat; and
receiving, based at least in part on displaying the option to enable the single amount setting, the input.

9. An apparatus for crypto token management, comprising:
one or more memories storing processor-executable code; and
one or more processors coupled with the one or more memories and individually or collectively operable to execute the code to cause the apparatus to:
receive a first amount of fiat to be associated with a user profile at a custodial token platform;
display, at a user interface of the custodial token platform, a fiat amount corresponding to the first amount and a stablecoin amount corresponding to a second amount of stablecoin associated with the user profile;
receive, at the custodial token platform, an input to enable a single amount setting;
convert, after receiving the input, the fiat amount to the stablecoin; and
display, at the user interface, the stablecoin amount without displaying the fiat amount, wherein the stablecoin amount is updated to include the converted fiat amount.

10. The apparatus of claim 9, wherein the one or more processors are individually or collectively further operable to execute the code to cause the apparatus to:
receive a third amount of fiat to be associated with the user profile at the custodial token platform;
convert, based at least in part on having received the input, the third amount of fiat to the stablecoin; and
display, at the user interface, the stablecoin amount that is updated to include the third amount of fiat.

11. The apparatus of claim 9, wherein, to convert the fiat amount to the stablecoin, the one or more processors are individually or collectively operable to execute the code to cause the apparatus to:
broadcast a message that is configured to call a minting contract for the stablecoin, the minting contract configured to mint an amount of the stablecoin equal to the fiat amount associated with the user profile, wherein displaying the stablecoin amount that is updated to include the converted fiat amount is based at least in part on broadcasting the message.

12. The apparatus of claim 11, wherein the message is configured to cause the converted fiat amount to be associated with a blockchain address associated with the user profile.

13. The apparatus of claim 9, wherein the one or more processors are individually or collectively further operable to execute the code to cause the apparatus to:
receive at the custodial token platform, a second input to disable the single amount setting.

14. The apparatus of claim 13, wherein the one or more processors are individually or collectively further operable to execute the code to cause the apparatus to:
display, based at least in part on receiving the second input and at a user interface of the custodial token platform, a fiat amount and a stablecoin amount associated with the user profile.

15. The apparatus of claim 14, wherein the fiat amount is zero.

16. The apparatus of claim 9, wherein, to receive the input to enable the single amount setting, the one or more processors are individually or collectively operable to execute the code to cause the apparatus to:
display, at the user interface, an option to enable the single amount setting based at least in part on receiving the first amount of fiat; and
receive, based at least in part on displaying the option to enable the single amount setting, the input.

17. A non-transitory computer-readable medium storing code for crypto token management, the code comprising instructions executable by one or more processors to:
receive a first amount of fiat to be associated with a user profile at a custodial token platform;
display, at a user interface of the custodial token platform, a fiat amount corresponding to the first amount and a stablecoin amount corresponding to a second amount of stablecoin associated with the user profile;
receive, at the custodial token platform, an input to enable a single amount setting;
convert, after receiving the input, the fiat amount to the stablecoin; and
display, at the user interface, the stablecoin amount without displaying the fiat amount, wherein the stablecoin amount is updated to include the converted fiat amount.

18. The non-transitory computer-readable medium of claim 17, wherein the instructions are further executable by the one or more processors to:
receive a third amount of fiat to be associated with the user profile at the custodial token platform;
convert, based at least in part on having received the input, the third amount of fiat to the stablecoin; and
display, at the user interface, the stablecoin amount that is updated to include the third amount of fiat.

19. The non-transitory computer-readable medium of claim 17, wherein the instructions to convert the fiat amount to the stablecoin are executable by the one or more processors to:
broadcast a message that is configured to call a minting contract for the stablecoin, the minting contract configured to mint an amount of the stablecoin equal to the fiat amount associated with the user profile, wherein displaying the stablecoin amount that is updated to include the converted fiat amount is based at least in part on broadcasting the message.

20. The non-transitory computer-readable medium of claim 19, wherein the message is configured to cause the converted fiat amount to be associated with a blockchain address associated with the user profile.
